(19) United States
(12) Patent Application Publication
(10) Pub. No.: US 2016/0148538 A1
(43) Pub. Date: May 26, 2016

(54) METHOD AND SYSTEM TO CONVERT PORTABLE DOCUMENT FORMAT FILE TO BRAILLE

(71) Applicant: SULTAN QABOOS UNIVERSITY, MUSCAT (OM)

(72) Inventors: AHMED MOHAMMED SALIM AL-BUSAIDI, MUSCAT (OM); AHMED SALIM KHLIFAH SALIM AL-ABRI, MUSCAT (OM); SAIF SALIM SAIF AL-FAREI, MUSCAT (OM); FAHAD SALIM SAIF AL-HASANI, MUSCAT (OM)

(21) Appl. No.: 14/810,401

(22) Filed: Jul. 27, 2015

Related U.S. Application Data
(60) Provisional application No. 62/082,595, filed on Nov. 20, 2014.

(51) Int. Cl. G09B 21/02

(52) U.S. Cl. CPC G09B 21/02

(57) ABSTRACT

The method and system to convert portable document format (PDF) file to Braille includes an electrical interactive refreshable dynamic board connected to a processor that inputs scanned text and outputs embossed Braille tactile indicia readable by anyone who can read Braille via the sense of touch. Piezoelectric actuators raise and lower Braille pins according to the translated scanned text. Moreover, the system supports Arabic language. Preferably, open source software is used for cross-platform compatibility. The GUI was developed in JAVA and the PDF conversion drivers were developed in C.

### CROSS-REFERENCE TO RELATED APPLICATION

This application claims the benefit of U.S. Provisional Patent Application Ser. No. 62/082,595, filed Nov. 20, 2014.

### BACKGROUND OF THE INVENTION

1. Field of the Invention

The present invention relates to tactile display apparatus, and particularly to a method and system to convert portable document format (PDF) files to Braille.

2. Description of the Related Art

The Braille system scripts for blinds were derived by Mr. Louis Braille in France. Louis was born on the 4th of January 1809 and died on the 6th of January 1852. Louis Braille devised the six embossed system based on a twelve-dot secret code system originally developed by Charles Barbier for the French Intelligence that soldiers could communicate silently and without light at night.

The Braille system is a method that is widely used by blind and partially sighted people to read and write. Each Braille character or cell is made up of six dot positions, arranged in a rectangle containing two columns of three dots each. Each dot has an assigned number between one and six. Braille combinations of six dots are arranged in two columns by three rows, the first column being numbered 1, 2, 3, and the second column being numbered 4, 5, 6. Each Braille cell could have 2ⁿ combinations with n dots. In other words, six dots Braille cell can be arranged in 64 combinations, each representing a different character. There is no separate set of symbols for capital letters in Braille. Capitalization is done by placing a dot “6” in the cell just before the letter that is capitalized. FIG. 4 shows the phrase “SQU” in Braille language. The first ten letters of the alphabet are used to make numbers. These are expressed by the letters “a” to “j” preceded by the numeric indicator, which is dots “3-4-5-6”.

Modern technology has made many useful tools for people who read and write Braille, and there are many research studies to come up with new technology that can represent Braille language in a refreshable board. A refreshable Braille display is an electro-mechanical device for displaying Braille characters, usually by means of round-tipped pins raised through holes in a flat surface. There are some products available in the market that produce books in Braille and other that allow people to read information from computers and the Internet by the sense of touch.

Braille printers or embossers are devices that are connected to computers that will do the actual embossing of Braille onto thick, heavy-weight paper. Embossers work just like a regular computer printer, which allows the user to print out reports and other files from the computer. Electronic Braille note takers are portable devices with Braille keyboards that Braille readers can use to enter information. The text stored in these devices can be read with a built-in Braille display. These devices are handy for taking notes and often have built-in address books, calculators, and calendars.

A Braille display is a device that has a row of special cells. The pins are controlled by a computer and move up or down to display, in Braille, the characters that appear on the computer screen. This type of Braille is said to be “refreshable” because it changes as the user moves around on the screen. The Braille display usually sits under the computer keyboard.

Nearly all Braille modules available today use piezoelectric ceramic bimorph reeds to actuate the Braille dots. The piezoelectric reeds are mounted as a stair stepped stack of cantilevers, each with a Braille pin resting on its free end. Each reed can lift the dome top of its 1.5 mm diameter Braille pin approximately 0.5 mm above the reading surface. The problem with all of the aforementioned devices is cost, lack of Arabic language support, and lack of environmental friendliness.

Thus, a method and system to convert portable document format file to Braille solving the aforementioned problems is desired.

### SUMMARY OF THE INVENTION

The method and system to convert portable document format file to Braille includes an electrical interactive refreshable dynamic board connected to a processor that inputs scanned text and outputs embossed Braille tactile indicia readable by anyone who can read Braille via the sense of touch. Piezoelectric actuators raise and lower Braille pins according to the translated scanned text. Moreover, the system supports Arabic language. Preferably, open-source software is used for cross-platform compatibility. The GUI was developed in JAVA, and the PDF conversion drivers were developed in C.

These and other features of the present invention will become readily apparent upon further review of the following specification and drawings.

### BRIEF DESCRIPTION OF THE DRAWINGS

FIG. 1 is a flowchart of the software module operations for a system to convert portable document format file to Braille according to the present invention.

FIG. 2 is a block diagram of exemplary hardware used by the system to convert portable document format file to Braille according to the present invention.

FIG. 3 is an exploded, perspective view showing the housing of the hardware for a system to convert portable document format file to Braille according to the present invention.

FIG. 4 is a schematic diagram showing Unicode and the corresponding 8-pin Braille system used by the present method to convert portable document format file to Braille according to the present invention.

FIG. 5 is a flowchart showing processing for the control keyboard in a system to convert portable document format file to Braille according to the present invention.

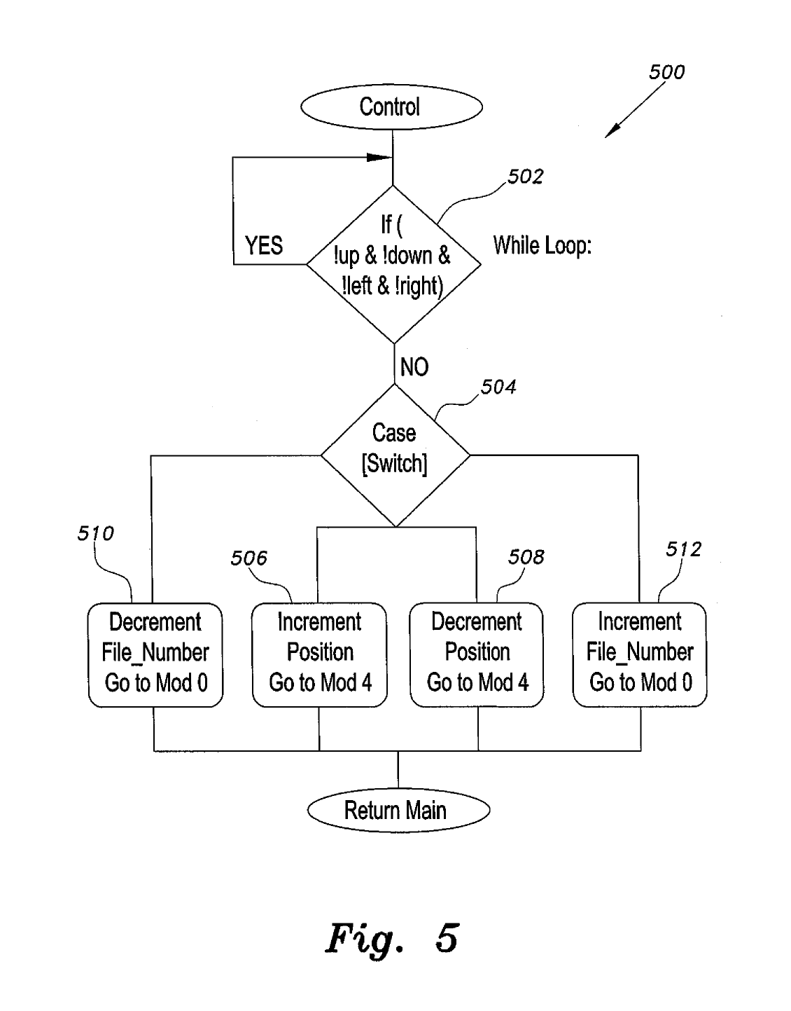

FIG. 6 is a pictorial diagram showing the Unicode vs actual pin output of the Braille tactile display device for English conversion in a system to convert portable document format file to Braille according to the present invention.

FIG. 7 is a pictorial diagram showing the Unicode vs actual pin output of the Braille tactile display device for Arabic conversion in a system to convert portable document format file to Braille according to the present invention.

Similar reference characters denote corresponding features consistently throughout the attached drawings.

### DETAILED DESCRIPTION OF THE PREFERRED EMBODIMENTS

The method and system to convert portable document format file to Braille utilizes an electrical interactive refreshable dynamic board connected to a processor that inputs scanned text and outputs embossed Braille tactile indicia readable by anyone who can read Braille via the sense of touch. Piezoelectric actuators raise and lower Braille pins according to the translated scanned text. Moreover, the method supports Arabic language. Open source software was used for cross-platform compatibility.

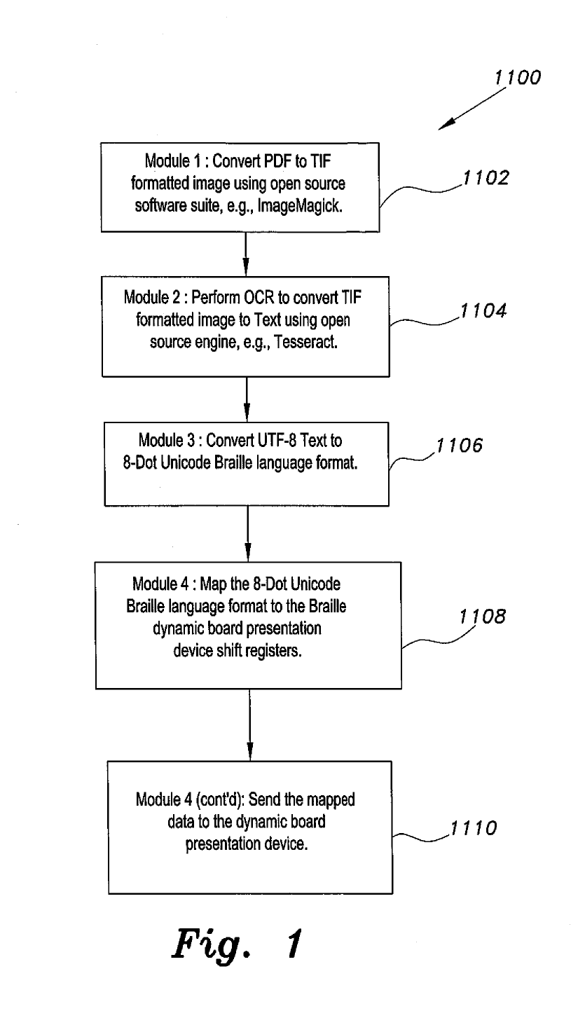

In the present software design 1100, as shown in FIG. 1, a first module 1102 converts PDF to a TIF image file with the aid of an open source program called ImageMagick®. ImageMagick® is an open source software suite to create, edit, compose, or convert bitmap images to any other format through the command line. It can read and write images in a variety of formats (over 100 formats), and it can be used in many operating systems (cross-platform). This module has been achieved by using ImageMagick® that will convert PDF to TIF and other formats. The mode of action of this module depends upon some parameters (such as density and depth) that will affect the output format. To convert a PDF file into TIF, a couple of steps must be satisfied. Module 1 has been successfully achieved through the terminal by sending the following command line to the terminal: C:\[PATH]-\ImageMagick\convert-monochrome-density 150-depth 8 C:\[INPUT PATH]\ENG_IMAGE_P1.pdf C:\[OUTPUT PATH]\ENG_IMAGE_P1.pdf.tif. It is shown from the conversion code that the path of the file should be included, followed by monochrome, which is gray scale image. After that, other features must be mentioned, such as density and depth 8 (Tesseract handles 8-bit images only). Finally, the input PDF file and the output TIF file should be there also. Module 1 processing includes a check to see if the TIF file exists, and if it does, processing continues in the other modules with no further action from module 1. If the TIF file does not exist, then the PDF to TIF file conversion is performed using the open source ImageMagick® code.

A second module 1104 converts the TIF image to Text, which is also known as an OCR process, and this process is done using an open source OCR engine called Tesseract, which was developed at HP Labs between 1985 and 1995, and now is at Google. Module 2 1104 assumes that Module 1 1102 has been achieved, i.e., converting a PDF file to a TIF file using ImageMagick software has been achieved. The TIF file to text conversion process module 2 1104 is achieved by using the Tesseract engine. Tesseract is a command-line program, so first the terminal or command prompt is opened, then the following is typed, as shown in Table 1.

TABLE 1
Tesseract Commands

C:\Users\Oman>tesseract
Usage:Tesseract imagename output base [-l lang] [-psm
pagesegmode] [configfile...]
pagesegmode values are;
0 = Orientation and script detection <OSD> only
1 = Automatic page segmentation with OSD.
2 = Automatic page segmentation, but no OSD, or OCR
3 = Fully automatic page segmentation, but no OSD. <Default>
4 = Assume a single column of text of variable sizes.
5 = Assume a single uniform block of vertically aligned text.
6 = Assume a single uniform block of text.
7 = Treat the image as a single text line.
8 = Treat the image as a single word.
9 = Treat the image as a single word in a circle.
10 = Treat the image as a single character.
-l lang and/or -psm pagesegmode must occur before anyconfigfile
Single options:

-v -version: version info
--list-langs: list available languages for tesseract engine

For Arabic language OCR use the following command:

tesseract C:\[PATH]\ARA_IMAGE_P3.pdf.tif C:[PATH]\ARA_IMAGE_P3.pdf-1 ara.

The language is specified after the “−1” command, whereas for English, use “eng”, and use “ara” for Arabic. The module 2 processing checks if a text file exists, and if it does not exist, module 2 1104 will convert the TIF file to text using Tesseract.

Module three 1106 converts Universal Character Set Transformation Format-8 (UTF-8) Text to 8-Dot Unicode Braille language format. Letters and Numbers are represented in a computer by numeric codes that require a certain method to refer it on. An encoding defines a mapping from a code point sequence to a byte sequence (and vice versa). A byte is a sequence of eight bits, represented as a double-digit hexadecimal number in the range 0x00 to 0xFF. A code point is a Unicode code point and is represented as a four-to-six digit hexadecimal number, typically prefixed with “U+”. Each encoding also has a decoder and encoder algorithm.

A decoder algorithm takes a byte sequence and gives a code point sequence. The byte pointer is initially zero, pointing to the first byte in the sequence. It cannot be negative. It can be increased and decreased to point to other bytes in the sequence. A decoder must be invoked again when the word continue is used.

An encoder algorithm takes a code point sequence and gives a byte sequence. It fails when a code point is passed for which it does not have a corresponding byte (sequence). An encoder must be invoked again when the word “continue” is used. Moreover, there are character encoding referred to letter's “ASCII value and ANSI value”. ASCII (American Standard Code for Information Interchange) is a 7-bit standard that has been around since the late 1950s. It defines 128 different characters, which is more than enough for English: upper- and lowercase letters, punctuation, numerals, control codes and nonprinting codes such as tab, return, and backspace.

Therefore, Unicode fixes the limitations of ASCII, by providing enough space for over a million different symbols. Note that all Unicode numbers are Hexadecimal. Unicode covers most of the world's writing systems. Most importantly, the mapping is consistent, so that any user anywhere on any computer has the same encoding as everyone else, no matter what font is being used.

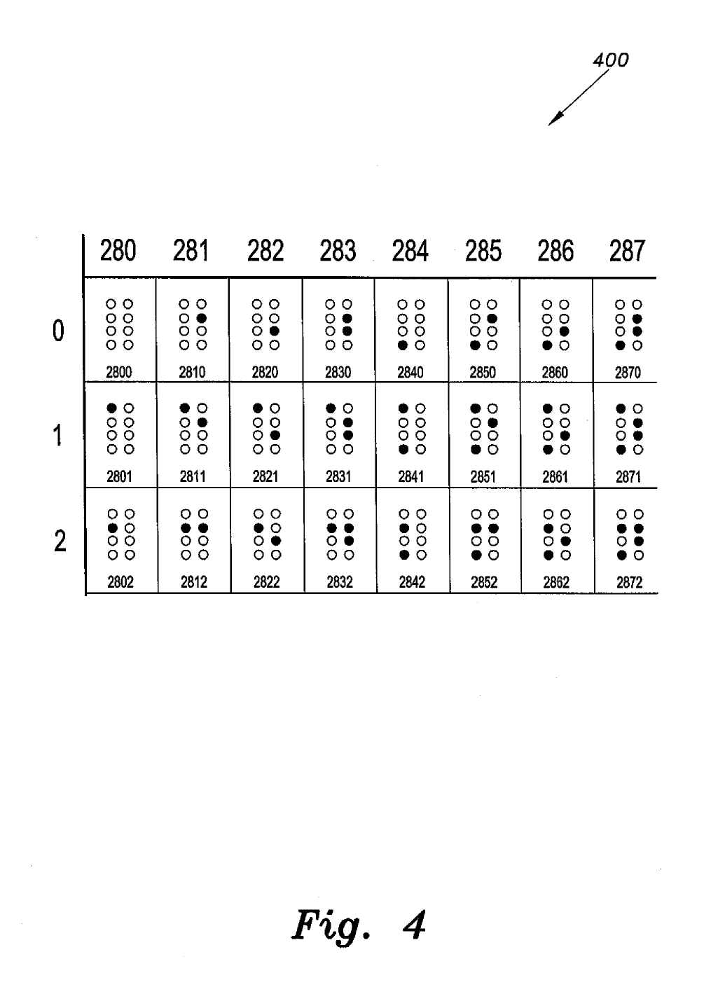

Unicode is a map, a chart of (what will one day be) all of the characters, letters, symbols, punctuation marks, etc., necessary for writing all of the world's languages past and present. Unicode has different types, such as UTF-8 and UTF-16. UTF-8 uses a variable byte to store a Unicode. In different code range, it has its own code length, varies from 1 byte to 6 bytes because it varies from 8 bits (1 byte), it is so called “UTF-8”. An exemplary Unicode for Braille system 400 is shown in FIG. 4.

The UTF-8 is suitable to be used on the Internet, networks, or in some kinds of applications. The UTF-16 is the Unicode Transformation Format that serializes a Unicode scalar value (code point) as a sequence of two bytes, in either big-endian or little-endian format. Because it is grouped by 16-bits (2 bytes), it is also called “UTF-16”. Table 2 shows a comparison between different types of UTF.

TABLE 2
UTF Type Comparison

| | | | UTF- | | | UTF- | |
|---|---|---|---|---|---|---|---|
| Name | UTF-8 | UTF-16 | 16BE | UTF-16LE | UTF-32 | 32BE | UTF-32LE |
| Smallest code point | 0000 | 0000 | 0000 | 0000 | 0000 | 0000 | 0000 |
| Largest code point | 10FFFF | 10FFFF | 10FFFF | 10FFFF | 10FFFF | 10FFFF | 10FFFF |
| Code unit size | 8 bits | 16 bits | 16 bits | 16 bits | 32 bits | 32 bits | 32 bits |
| Byte order | N/A | <BOM> | big | little | <BOM> | big endian | little endian |
| | | | endian | endian | | | |
| Minimal bytes/character | 1 | 2 | 2 | 2 | 4 | 4 | 4 |
| Maximal bytes/character | 4 | 4 | 4 | 4 | 4 | 4 | 4 |

As of Unicode 6.1, the Arabic script is contained in the blocks shown in Table 3.

TABLE 3
Arabic Unicode Blocks

| | |
|---|---|
| Arabic | 0600-06FF, 255 characters |
| Arabic Supplement | 0750-077F, 48 characters |
| Arabic Extended-A | 08A0-08FF, 39 characters |
| Arabic Presentation Forms-A | FB50-FDFF, 608 characters |
| Arabic Presentation Forms-B | FE70-FEFF, 140 characters |
| Arabic Mathematical Alphabetic Symbols | 1EE00-1EEFF, 143 characters |

The basic Arabic range encodes the standard letters, diacritics and Arabic-Indic digits. The Arabic Supplement range encodes letter variants mostly used for writing African (non-Arabic) languages. The Arabic Extended-A range encodes additional Qur'anic annotations and letter variants used for various non-Arabic languages. The Arabic Presentation Forms-A range encodes contextual forms and ligatures of letter variants needed for Persian, Urdu, Sindhi and Central Asian languages.

The Arabic Presentation Forms-B range encodes spacing forms of Arabic diacritics, and more contextual letter forms. The Arabic Mathematical Alphabetical Symbols block encodes characters used in Arabic mathematical expressions.

After recognizing the stored UTF-8, encoding and being familiar with it can be easy, thereby facilitating the implementation of the mapping process to any Braille language. This Module 3 1106 has been completed by using functions of liblouis, which are written in C language, and which will allow conversion of text to Braille. Liblouis is an open source Braille translator having features that support the literary Braille, besides supporting the contracted and uncontracted translation for several languages, including English and Arabic. It takes UNICODE or ASCII and maps it with Braille, while the library uses the predefined tables for each language on the mapping process. Module 3 1106 is error-free because each character has its own mapping so that error does not exist at all. Module 3 1106 has been successfully achieved through the terminal by sending the following command line to the terminal: C:\[PATH]\convert\Text2Braille C: \[INPUT PATH]\ENG_IMAGE_P1.pdf.txt C: \[OUTPUT PATH]\ENG_IMAGE_P1.pdf.txt.txt. The Module 3 1106 processing checks whether the Braille file exists, and if the Braille file does not exist, the module converts the text to Braille using the liblouis library.

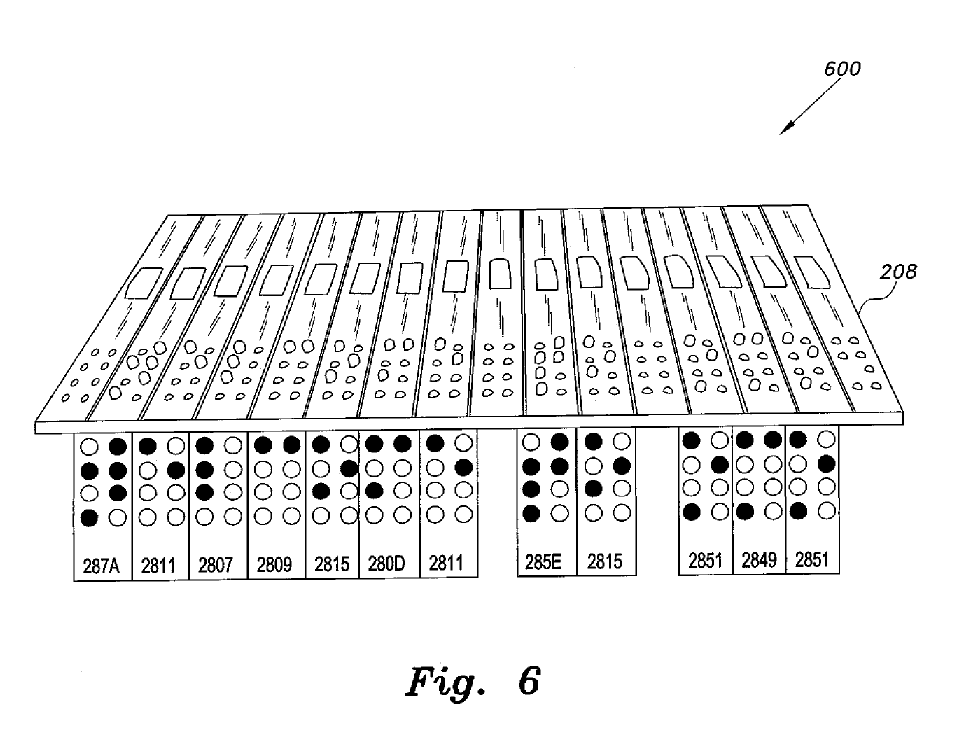

Module 4 1108 is a mapping algorithm, since the exemplary dynamic board 208 (shown in FIG. 6, configuration 600 for English language testing) uses shift registers to raise or lower Braille pins. Due to the fact that the dynamic board 208 uses shift registers to control the actual embossed Braille pins, the dynamic board comes with its own mapping datasheet. Module 4 1108 includes a sub-module 1110 that sends mapped data to the dynamic board 208, which is used to present the actual Braille language for the blind people. Module 4 1108 operates the dynamic board 208 (“Braille Flat-20”). The Braille Flat-20 dynamic board 208 is used to represent Braille language of imposed dots for blind people. Dynamic board 208 is a compact block with 20 Braille cells having an integrated electronic driver and a 200-Volt converter power supply for the piezoelectric actuators. Table 4 shows the dynamic board 208 (Braille Flat 20) pin-out configuration.

TABLE 4
Dynamic Board Pin-out Configuration

| Pin Number | Description |
|---|---|
| 1 | Ground |
| 2 | +5 Volts |
| 3 | Data out |
| 4 | Data in |
| 5 | Strobe/Latch |
| 6 | Clock |
| 7 | Not Connected (open) |
| 8 | +5 Volts |
| 9 | Ground |
| 10 | Not Connected (open) |

The communication is done by writing to the output shift-register, while data are clocked in with the positive edge of the Clock signal. The content of this shift-register is written to the output with the falling edge of the Strobe signal. The dynamic board 208 uses its own mapping datasheet to display Braille language. This is because the dynamic board 208 uses shift registers to control the actual embossed Braille pins.

For the keys, there is a separate input shift register that operates so that the keys input is transferred to the input shift register while the Strobe is high. When the Strobe is low, input signal keys are clocked out at the rising transition of the Clock. There are two keys for each module. The even-bit numbers are the keys in the front row. The high-voltage converter can be switched off by applying a logic Low at the shutdown pin to set the device in a low power condition. When the shutdown mode is not used, the shutdown pin can be left open because of an internal pull-up resistor. To de-bounce any key inputs to the processor, an RC circuit in conjunction with a Schmidt trigger is used, as is well known by those of ordinary skill in the art.

An interrupt routine is used to send a signal to a microprocessor (e.g., the Raspberry Pi™ microprocessor in computing system 204) to get its attention. Devices connected to the microprocessor can send a signal to the microprocessor when there is an input to get the processor's attention. The interrupt request is asynchronous and can occur at any time. The programmer does not know in advance when the request would occur. The processor responds by suspending its current activities, saving its state, and executing a small program called an interrupt handler (or interrupt service routine, ISR) to deal with the event. This interruption is temporary, and after the interrupt handler finishes, the processor resumes execution of the previous thread. Both hardware interrupts (an electronic alerting signal sent to the processor from an external device), and software interrupts (caused either by an exceptional condition in the processor itself, or a special instruction in the instruction set) are used.

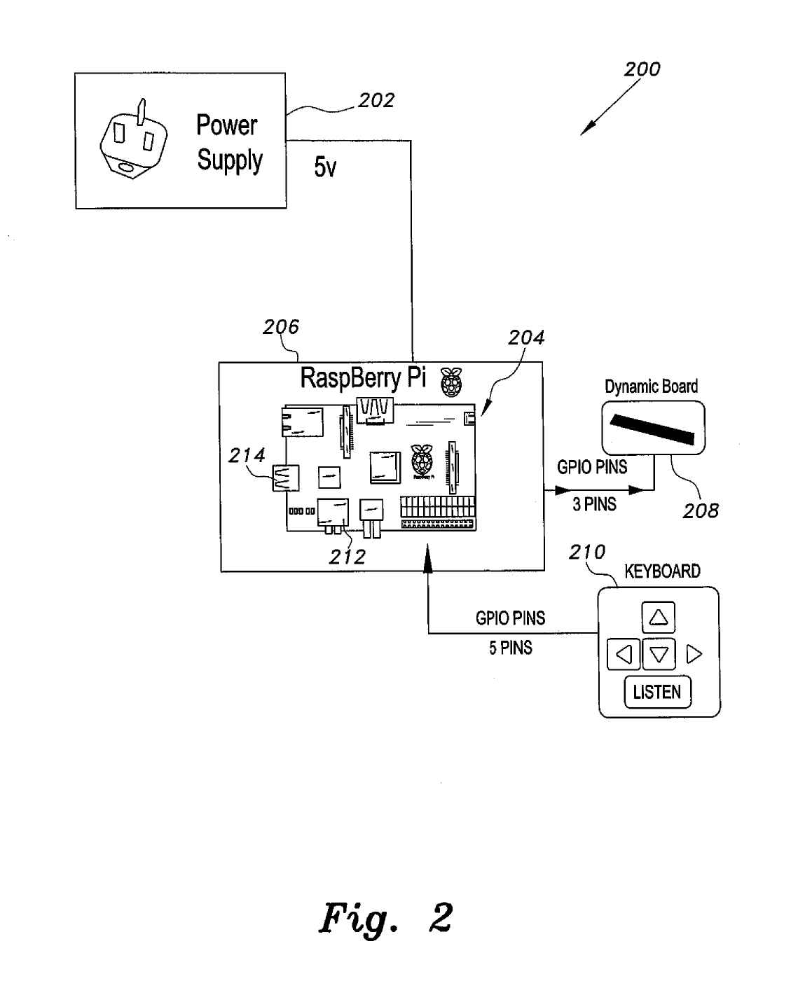

Each interrupt has its own interrupt handler. The number of hardware interrupts is limited by the number of interrupt request (IRQ) lines to the processor, but there may be hundreds of different software interrupts. Interrupts are a commonly used technique for computer multitasking, especially in real-time computing. Such a system is said to be interrupt-driven. The computing system 204 (shown in FIG. 2) was tested on Windows operating system at first. Moving to Unix-like operating systems would require reprogramming from scratch, but actually there are several ways to overcome this problem. “Wine” is a free and open source software application that aims to allow applications designed for Microsoft Windows to run on Unix-like operating systems. Wine allows running executable (.exe) files in a Unix-like OS. An alternative would be using mingw compiler to recompile the code to create the executable (.exe) file, and then run it using Wine. The C code is modified such that a gcc compiler would be able to compile the required application. The exemplary code shown in Table 5 can be used to read UTF-8 characters from a file.

TABLE 5
Read UTF-8 Characters From A File
C code for UTF-8 character read

```
    #include <locale.h>
    #include <stdio.h>
    #include <wchar.h>
    #include <stdlib.h>
int main (int argc, char *argv[ ]){
    setlocale(LC_ALL, “C.UTF-8”);
          FILE * fin;
          FILE * fout;
          wint_t wc;
      fin=fopen (argv[1],“r”);
      fout=fopen(argv[2],“w”);
  while((wc=fgetwc(fin))!=WEOF){
            // work with wc
                }
          fclose(fin);
          fclose(fout);
  printf(“File has been created...\n”);
            return 0;
            }
```

The main application holding all modules together was written in Python programming language. Python is much easier in data and array handling. Moreover, Python is a cross-platform language. In other words, once Python is installed, there is no need to edit program scripts from one operating system to another.

The overall system 200 may utilize any suitable operating system, such as Windows or Linux. The computing system 204 may be compatible with any suitable processor, such as the aforementioned Raspberry Pi™ (Raspberry Pi is a trademark of the Raspberry Pi Foundation), or any other suitable development board. The system 200 may have an attractive and ergonomic casing in order to commercialize it and to be a unique product in the market.

Blind people have the right to know the new events and news that happens around the world, so the project will have an optional feature that will allow blind people to read the news in an easy way. This feature can be done by using Wi-Fi or Bluetooth technology to interact with other devices.

There are many types of processors that can do multiple tasks at the same time. Moreover, those processors have two main different features regarding the operating system. Some of them need an external device with an operating system to program them, while others contain an operating system. It has been found that Raspberry Pi™ is the most suitable processor for the project that gives the needed functionality.

Raspberry Pi™ is a mini desktop PC 204. It operates with the Raspbian distribution of the Linux Operating System. It has 26 GPIO (General Purpose Input Output) with 700 MHz CPU, 512 MB RAM and 2 USB Ports. It should be understood by one of ordinary skill in the art that embodiments of the present portable document format (PDF) file to Braille code conversion method can comprise software or firmware code executing on a computer, a microcontroller, a microprocessor, or a DSP processor; state machines implemented in application specific or programmable logic; or numerous other forms without departing from the spirit and scope of the invention. The present portable document format (PDF) file to Braille code conversion method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

In the present design, the circuit of the full system 200 has been implemented where a single feature of the Battery Management System (BMS) in power supply 202 monitors the voltage of the battery so that the battery does not get overcharged and damaged. A booster circuit is used to step up the voltage from 3.7 volts to 5.0 volts, since the Raspberry Pi™ computing system 204 requires a 5V supply voltage. Two types of break-out have been used. The first break-out is a Micro USB breakout to connect the Raspberry Pi™ with the booster circuit, and the second break-out is a DIP (dual in-line packaging) to FFC (flat flexible connector) that will connect the Raspberry Pi™ with the dynamic board through an FFC cable. An SD (secure digital) card is needed to store the operating system for the Raspberry Pi™, and finally a connection is provided to the control buttons 210 that will be used by the blind person to navigate between and within different files,

Battery Management System (BMS) has different meaning to different people. Some of them consider it as a simple Battery Monitoring, keeping a check on the parameters during charging and discharging processes, such as voltages and currents and ambient temperature. If one of the parameters gets out of limit, the monitoring system will normally provide input to protection devices that would generate an alarm or disconnect the battery from the load or charger. For the automotive engineer, the BMS is a component of a much more complex fast acting Energy Management System and must interface with other on-board systems, such as engine management, climate controls, communications and safety systems. Therefore, there are many varieties of BMS.

In the present system, a USB Li-Poly charger is used. This charger maintains charge of Li—Po batteries rapidly without taking a long time. It is considered as a basic charger that allows users to charge 33 volt at a specific current rate of 500 mA or down to 100 mA. A number of applications these days use this device, such as Personal Data Assistants (PDAs), Cellular Telephones, Digital Cameras, MP3 Players, Bluetooth Headsets, USB Chargers, and Lithium-Ion/Lithium-Polymer Battery Chargers. The charger in power supply 202 includes a charge management controller internally, which contains such features as linear charge controller, programmable charge current, charge status output and thermal regulation. The lithium polymer (Li—Po) battery is preferable because of its superior specific energy (130-200 Watt-hours/kilogram). More specifically, the USB Li-Poly charger is a SparkFun® charger board that utilizes Microchip® MCP 73831/2 controller chips, which are highly advanced linear charge management controllers for use in space-limited, cost-sensitive applications, the charger device allowing users to charge 3.7 volt at a specific current rate of 500 mA or down to 100 mA.

FIG. 2 shows that the input to the micro-controller can be classified into three types. The first and second types of input are USB interrupt and left/right, respectively. That is, if a USB drive is inserted or if the buttons left/right were pushed, the system will select a PDF file. Then, the selected file will be processed into four different Modules such that the final output should be in Braille language. Moreover, the system will wait for another user input. The up/down controls will change what is displayed within the same file.

The printed circuit board (PCB) 206 of computing system 204 is more powerful than the previous boards, thus avoiding human errors caused by installing wires and cutting lines in Copper Board. In this project, Fritzing software has been used to design the circuit as a breakout board, since this project has external processor (Raspberry Pi™) in computing system 204, battery management system (BMS) of power supply 202, dynamic board 208, Push button keyboard 210, and a power switch associated with power supply 202. The PCB 206 has male and female headers that connect the Raspberry Pi™ through a 26-flat cable and connect the Dynamic Board via flat Flexible Cable (FFC), implemented on a FFC to general-purpose input/output (GPIO) Breakout board. Also, this PCB connects the battery charger with a step-up circuit and powers the processor through a micro USB connector. This PCB contains a power switch for the project, located between the step-up circuit and the battery charger. The switch location was chosen near the battery charger that requires disconnection of any sinking components to charge the battery. Also, the pushbutton circuit of keyboard 210 has a cable place with male headers, which will connected to the PCB via 4-Female to Female Group wires and male headers on it. The overall PCB has the dimensions 100 mm by 60 mm and has 6 holes for mounting screws.

The prototyping of the first phase of the present portable document format (PDF) file to Braille code conversion system used Raspberry Pi™ as a main processor, which works with 5V, the same as the voltage used by the Dynamic Board 208. This means that the system 200 will work with a 5V power supply. There are two inputs and two outputs to the setup. The inputs are USB Storage (Flash Memory) 214 and the control keyboard 210. The USB storage will contain the PDF files, which users will want to read via Braille Language. The second input is for the control button keyboard 210, which has 5 control buttons, namely, LEFT, RIGHT, UP, DOWN and LISTEN. These control buttons use a set of 5 GPIO pins from the selected processor of computing system 204. A user control program 500 processes the control buttons, checking for UP, DOWN, LEFT, RIGHT button presses at step 502. When a button is pressed, a case decision block 504 directs processing to the appropriate response where alternatively, allowing a user to select text within a file for conversion to Braille, a position within an open file is incremented at step 506, or decremented at step 508, or, allowing a user to select files for conversion to Braille, a file number is decremented at step 510, or the file number is incremented at step 512. When the LISTEN button is pressed, a text-to speech engine is activated to allow the user to hear the file contents being converted to Braille.

The first output is for the dynamic board 208, which tactilely displays Braille language to users. The dynamic board 208 works with piezoelectric material technology. The dynamic board 208 is connected to the processor of computing system 204 via a set of 3 GPIO pins through a 10-way FFC cable. The second output is an audio jack 212 for the speakers (head phone), which will work using the TEXT to Speech engine of the main algorithm utilized by the present system.

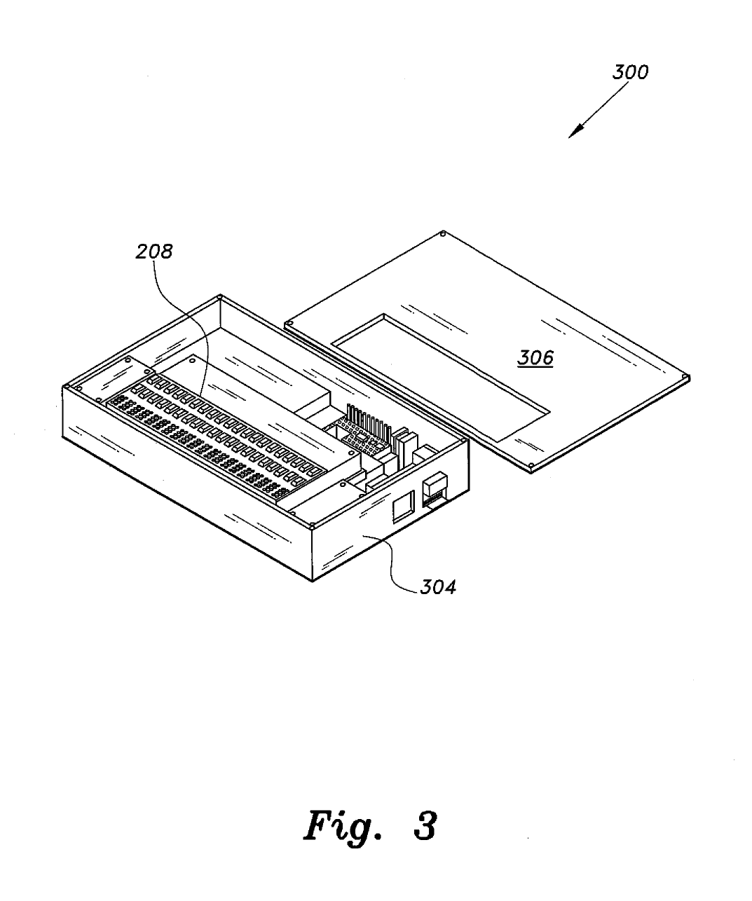

As shown in FIG. 3, casing 300 is an important part in the esthetic design, which has a rectangular cavity 304 in which the electronic components, including the dynamic board 208, fit. The cover 306 to the device 300 has an opening through which the keyboard 210 and the dynamic board 208 are accessible to the user. The casing 300 was designed using a 3D program (SolidWorks).

Three different settings have been tested for Module 1 1102 by changing the output image density and keeping the depth because the next module requires 8-bit only to do its own process. Varying these parameters has a direct impact on the output TIF file. For example, if the density is low, it will make the process faster, but the quality is too low for the optical character recognition (OCR) process. On the other hand, high density yields a high resolution output file that will lead to better OCR process. However, this will take longer time to process and requires more disk space for each image created.

Table 6 shows the testing results carried out on four PDF files with different numbers of pages, sizes and languages. Each file was tested under three different density parameters. Both the time required to convert the PDF to TIF and the size of the produced TIF file was recorded.

TABLE 2
Testing results for Module 1
Input Parameters

| | Language | | | |
|---|---|---|---|---|
| | English | | Arabic | |
| Type | Image | Text | Image | Text |
| Pages | 1 | 4 | 3 | 2 |
| PDF Size | 475 KB | 23 KB | 358 KB | 101 KB |

Output for density = 150, depth = 8

| | | | | |
|---|---|---|---|---|
| TIF Image Size | 2,057 KB | 8,228 KB | 6,171 KB | 4,114 KB |
| Module 1: | 780 ms | 1,809 ms | 2,511 ms | 1,326 ms |
| Time Taken | | | | |

Output for density = 250, depth = 8 and

| | | | | |
|---|---|---|---|---|
| TIF Image Size | 5,715 KB | 22,858 KB | 17,143 KB | 11,429 KB |
| Module 1: | 1,139 ms | 3,572 ms | 5,725 ms | 1,966 ms |
| Time Taken | | | | |

Output for density = 350, depth = 8

| | | | | |
|---|---|---|---|---|
| TIF Image Size | 11,201 KB | 44,803 KB | 33,603 KB | 22,402 KB |
| Module 1: | 1,872 ms | 5,944 ms | 10,374 ms | 3,339 ms |
| Time Taken | | | | |

Table 7 shows three different settings used for testing Module 2 1104. The table clearly shows that when the density is changed, it will affect the output, process time and errors in the OCR process. For example, if the density is low, the process will be very fast, but this might lead into many errors in the processed OCR text. On the other hand, if the density is increased to a high value, it will increase the time taken in the OCR process, but with fewer errors in the OCR process. Also, the table shows that processing text written in Arabic language takes more time than the one written in English language due to the way OCR treats Arabic language, as mentioned earlier. Moreover, Table 7 shows the percentage error of the OCR process between the original PDF file and the processed text for different TIF densities in terms of words that do not match the original file.

TABLE 3
Testing results for Module 2
Input Parameters

| | Language | | | |
|---|---|---|---|---|
| | English | | Arabic | |
| Pages | 1 | 4 | 3 | 2 |
| Number of | 290 | 1,054 | 869 | 520 |
| words | | | | |

Output for density = 150, depth = 8

| | | | | |
|---|---|---|---|---|
| Input TIF | 2,057 KB | 8,228 KB | 6,171 KB | 4,114 KB |
| Image Size | | | | |
| Module 2: | 1,950 ms | 4,337 ms | 13,026 ms | 11,903 ms |
| Time Taken | | | | |
| OCR Per- | 0.7% | 0.6% | 17.0% | 4.6% |
| centage | | | | |
| Error | | | | |

Output for density = 250, depth = 8

| | | | | |
|---|---|---|---|---|
| Input TIF | 5,715 KB | 22,858 KB | 17,143 KB | 11,429 KB |
| Image Size | | | | |
| Module 2: | 2,449 ms | 4,618 ms | 17,972 ms | 16,348 ms |
| Time Taken | | | | |
| OCR Per- | 0.4% | 0.4% | 21.6% | 3.1% |
| centage | | | | |
| Error | | | | |

Output for density = 350, depth = 8

| | | | | |
|---|---|---|---|---|
| Input TIF | 11,201 KB | 44,803 KB | 33,603 KB | 22,402 KB |
| Image Size | | | | |
| Module 2: | 3,307 ms | 6,100 ms | 23,618 ms | 20,062 ms |
| Time Taken | | | | |
| OCR Per- | 0.4% | 0.1% | 24.9% | 4.2% |
| centage | | | | |
| Error | | | | |

The results show that as the density is increased, the error percentage will decrease. This is expected, since increasing the resolution leads to a better quality image. Furthermore, processing time and storage space are increased due to the increase in density. The Arabic PDF file with 3 pages has a high error percentage, and this might be due to the type of font used in that file. A better result might have been achieved by changing the quantization process of ImageMagick®.

Table 8 shows the Module 3 1106 testing results carried on four PDF files with different numbers of pages, sizes and languages. Each file was tested under three different density parameters, and the time required to convert the text to Braille was recorded.

TABLE 4
Testing results for Module 3
Input Parameters

| Language | |
|---|---|
| English | Arabic |

| | | | | |
|---|---|---|---|---|
| Type | Image | Text | Image | Text |
| Pages | 1 | 4 | 3 | 2 |

Output for density = 150, depth = 8

| | | | | |
|---|---|---|---|---|
| Module 3: | 62 ms | 93 ms | 78 ms | 94 ms |
| Time Taken | | | | |

Output for density = 250, depth = 8

| | | | | |
|---|---|---|---|---|
| Module 3: | 63 ms | 109 ms | 93 ms | 63 ms |
| Time Taken | | | | |

Output for density = 350, depth = 8

| | | | | |
|---|---|---|---|---|
| Module 3: | 78 ms | 94 ms | 78 ms | 47 ms |
| Time Taken | | | | |

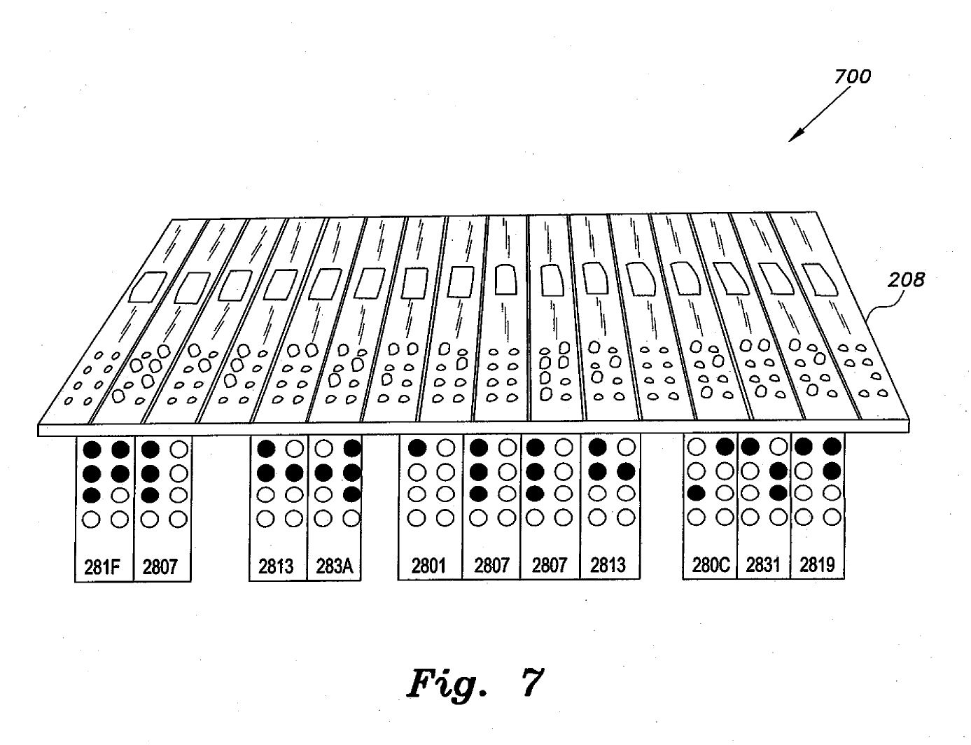

The dynamic board (Module 4 1108) testing validates the functionality of the present system after integrating all components. The test carried out validated the end-to-end process (i.e., from the supplying an image to the system 200, until the Braille pins are embossed on the dynamic board 208). Therefore, two samples of the input will be tested in English as first, and then in Arabic. As shown in test setup 700 of FIG. 7, the full system has been tested for many trials to observe the output patterns of Braille in the dynamic board 208. It can be seen that there are dots, which are raised up or down depending on the input word that needs to be read. In the above example, which is displayed on the board and that represents the following sentence: “Welcome to ECE”, and which follows the UNICODE system standards mentioned previously, including encoding for the capital letters for each word. FIG. 7 also illustrates an example in Arabic language commensurate with the requirements of the project. A sentence (A'ayah) from the Holy Quraan { [symbol] } has been chosen to be displayed in the dynamic board 208 with the embossed dots.

Table 9 lists the various, Integrated Development Environments (IDE), operating systems (OS), programming languages, and open source libraries and engines that may be used to develop and implement the present portable document format (PDF) file to Braille code conversion method.

TABLE 5
Summary of Used OS's, IDE's, Programming
Languages and Open Source Engines
Operating Systems (OS)

| | |
|---|---|
| Windows 7 | Used for development purpose since it is |
| | widely used in Oman |
| Raspbian | Open Source Linux OS distribution used by |
| (Linux) | Raspberry Pi |

Integrated Development Environments (IDE)

| | |
|---|---|
| NetBeans | Open source IDE used for development framework |
| | in JAVA |
| Visual Studio | Proprietary software developed by Microsoft |
| 2008 | used for C/C++ development |

Programming Languages

| | |
|---|---|
| C/C++ | Used to develop all module since C/C++ |
| | performance is better than JAVA |
| JAVA | Used to since graphical user interface is |
| | much easier for developers |

Open Source Libraries/Engines

| | |
|---|---|
| ImageMagick ® | Open source software suite for converting, |
| | and editing image files |
| Tesseract | An optical character recognition engine for various |
| | operating systems. It is free software and development |
| | has been sponsored by Google since 2006 |
| Liblouis | Liblouis is an open-source Braille translator |
| | and back-translator. |

Table 10 shows a summary of results when testing the performance of the modules.

TABLE 6
Testing Summary of Module 1, Module 2 and Module 3
Input Parameters

| | Language | | | |
|---|---|---|---|---|
| | English | | Arabic | |
| Type | Image | Text | Image | Text |
| Pages | 1 | 4 | 3 | 2 |
| PDF Size | 475 KB | 23 KB | 358 KB | 101 KB |
| Number of | 290 | 1,054 | 869 | 520 |
| words | | | | |

Output for density = 150, depth = 8

| | | | | |
|---|---|---|---|---|
| Input TIF | 2,057 KB | 8,228 KB | 6,171 KB | 4,114 KB |
| Image Size | | | | |
| Module 1: | 780 ms | 1,809 ms | 2,511 ms | 1,326 ms |
| Time Taken | | | | |
| Module 2: | 1,950 ms | 4,337 ms | 13,026 ms | 11,903 ms |
| Time Taken | | | | |
| OCR Per- | 0.7% | 0.6% | 17.0% | 4.6% |
| centage | | | | |
| Error | | | | |
| Module 3: | 62 ms | 93 ms | 78 ms | 94 ms |
| Time Taken | | | | |
| Total Time | 2,792 ms | 6,239 ms | 15.615 ms | 13,323 ms |

Output for density = 250, depth = 8

| | | | | |
|---|---|---|---|---|
| Input TIF | 5,715 KB | 22,858 KB | 17,143 KB | 11,429 KB |
| Image Size | | | | |
| Module 1: | 1,139 ms | 3,572 ms | 5,725 ms | 1,966 ms |
| Time Taken | | | | |
| Module 2: | 2,449 ms | 4,618 ms | 17,972 ms | 16,348 ms |
| Time Taken | | | | |
| OCR Per- | 0.4% | 0.4% | 21.6% | 3.1% |
| centage | | | | |
| Error | | | | |
| Module 3: | 63 ms | 109 ms | 93 ms | 63 ms |
| Time Taken | | | | |
| Total Time | 3,651 ms | 8,299 ms | 23,790 ms | 18,377 ms |

Output for density = 3 50, depth = 8

| | | | | |
|---|---|---|---|---|
| Input TIF | 11,201 KB | 44,803 KB | 33,603 KB | 22,402 KB |
| Image Size | | | | |
| Module 1: | 1,872 ms | 5,944 ms | 10,374 ms | 3,339 ms |
| Time Taken | | | | |
| Module 2: | 3,307 ms | 6,100 ms | 23,618 ms | 20,062 ms |
| Time Taken | | | | |
| OCR Per- | 0.4% | 0.1% | 24.9% | 4.2% |
| centage | | | | |
| Error | | | | |
| Module 3: | 78 ms | 94 ms | 78 ms | 47 ms |
| Time Taken | | | | |
| Total Time | 5,257 ms | 12,138 ms | 34,070 ms | 23,448 ms |

The increase in conversion density from PDF to TIF increases the execution time. The OCR process dominates the execution time, which is followed by the process of PDF to TIF conversion, which requires about half the execution time of that of the OCR process. It is worth noting that any increase in the resolution of the PDF to TIF conversion leads to increasing the storage requirements.

The quantization process of Module 1 is an essential factor of the full process, since the output is very sensitive to any changes in the OCR process settings. The results show that optimum density is 150 dots per inch (dpi), which has the advantage of least processing time and disk space, despite that fact that the percentage of errors from the OCR process are higher at this density level.

An embodiment of the present portable document format (PDF) file to Braille code conversion method may run on a hardware platform that includes several dual USB ports, four command buttons, and Ethernet as an input, while providing a 20 Braille cell output. Table 11 shows a summary of overall system features.

TABLE 7
Overall Project Feature

| | |
|---|---|
| Processor | ARM11 700 MHz, 512 MB RAM |
| Power Consumption | 660 mA |
| Dimensions | (190 × 42 × l21)mm |
| Languages Supported | Arabic + English |
| | (Compatible with 60+ languages) |
| Operating system | Raspbian (Linux) |
| Battery Capacity | 2000 mAh (3 Hours) |
| Net Weight | 680 gram |
| Extensions Supported | TIF, PDF & TXT |

It is to be understood that the present invention is not limited to the embodiments described above, but encompasses any and all embodiments within the scope of the following claims.

1. A computer-implemented method to convert a portable document format (PDF) file to Braille, comprising the steps of inputting a PDF file;
converting the PDF file to an image file;
performing optical character recognition (OCR) on the image file, wherein text characters embedded in the image file are recognized;
converting the recognized text characters to corresponding Braille codes, wherein the recognized text characters to corresponding Braille codes conversion step further comprises the step of converting Universal Character Set Transformation Format-8 (UTF-8) text to 8-Dot Unicode Braille language format, wherein the Universal Character Set Transformation Format-8 (UTF-8) text to 8-Dot Unicode Braille language format step further comprises the step of using an open source Braille translator having a library that supports literary Braille, wherein the using an open source Braille translator step further comprises the step of using open source Braille translator Liblouis, the Liblouis translator taking UNICODE or ASCII and mapping it with Braille so that each character has its own mapping so that errors are eliminated; and
outputting the corresponding Braille codes to a dynamic Braille tactile display device.

2. The computer-implemented method to convert a portable document format (PDF) file to Braille according to claim 1, further comprising the step of using Arabic Unicode blocks in the step of converting the recognized text characters to corresponding Braille codes.

3. The computer-implemented method to convert a portable document format (PDF) file to Braille according to claim 1, wherein the PDF to image file conversion comprises the step of converting the PDF file to a Tagged image Formatted (TIF) file.

4. The computer-implemented method to convert a portable document format (PDF) file to Braille according to claim 3, wherein the PDF file to TIF file conversion step further comprises the step of using open source software for creating, editing, composing, or converting bitmap images to any other format through a command line.

5. The computer-implemented method to convert a portable document format (PDF) file to Braille according to claim 4, wherein the open source software using step of claim 4 further comprises the step of using ImageMagick® to do the PDF to TIF conversion.

6. The computer-implemented method to convert a portable document format (PDF) file to Braille according to claim 1, wherein the optical character recognition (OCR) on the image file step further comprises the step of using an open source OCR engine to do the OCR.

7. The computer-implemented method to convert a portable document format (PDF) file to Braille according to claim 1, wherein the open source OCR engine using step further comprises the step of using Tesseract, a command-line OCR program.

8-10. (canceled)

11. A computer software product, comprising a non-transitory medium readable by a processor, the non-transitory medium having stored thereon a set of instructions for implementing portable document format (PDF) file conversion to Braille, the set of instructions including:
(a) a first sequence of instructions which, when executed by the processor, causes said processor to accept a PDF file as input;
(b) a second sequence of instructions which, when executed by the processor, causes said processor to convert the PDF file to an image file;
(c) a third sequence of instructions which, when executed by the processor, causes said processor to perform optical character recognition (OCR) on the image file wherein text characters embedded in the image file are recognized;
(d) a fourth sequence of instructions which, when executed by the processor, causes said processor to convert the recognized text characters to corresponding Braille codes, wherein the recognized text characters to corresponding Braille codes conversion step further comprises the step of converting Universal Character Set Transformation Format-8 (UTF-8) text to 8-Dot Unicode Braille language format, wherein the Universal Character Set Transformation Format-8 (UTF-8) text to 8-Dot Unicode Braille language format step further comprises the step of using an open source Braille translator having a library that supports literary Braille, wherein the using an open source Braille translator step further comprises the step of using open source Braille translator Liblouis, the Liblouis translator taking UNICODE or ASCII and mapping it with Braille so that each character has its own mapping so that errors are eliminated; and
(e) a fifth sequence of instructions which, when executed by the processor, causes said processor to output the corresponding Braille codes to a dynamic Braille tactile display device.

12. The computer software product according to claim 11, further comprising a sixth sequence of instructions which, when executed by the processor, causes said processor to use Arabic Unicode blocks to facilitate the recognized text characters to corresponding Braille codes conversion.

13. The computer software product according to claim 11, further comprising a seventh sequence of instructions which, when executed by the processor, causes said processor to convert the PDF file to a Tagged Image Formatted (TIF) file.

14. The computer software product according to claim 13, further comprising an eighth sequence of instructions which, when executed by the processor, causes said processor to use open source software that can create, edit, compose, or convert bitmap images to any other format through a command line.

15. The computer software product according to claim 14, further comprising a ninth sequence of instructions which, when executed by the processor, causes said processor to use ImageMagick® to do the PDF to TIF conversion.

16. The computer software product according to claim 11, further comprising a tenth sequence of instructions which, when executed by the processor, causes said processor to use an open source OCR engine to do the OCR.

17-18. (canceled)

19. A system to convert a portable document format (PDF) file to Braille, the system comprising:
a computing system having a microprocessor, a plurality of General Purpose Input Output (GPIO) terminals, random access memory (RAM) and a plurality of USB Ports, said GPIO terminals, RAM and USB Ports being in operable communication with the microprocessor, at least one of the USB ports being configured for inputting a PDF file to the computing system for conversion to Braille;
a control keyboard connected to a first set of the GPIO terminals, the control keyboard having means for allowing a user to select files for conversion to Braille, for selecting text within a file for conversion to Braille, and for activating a text-to-speech engine to allow the user to hear contents of the selected file being converted to Braille;
means for converting the PDF file to an image file;
means for performing optical character recognition (OCR) on the image file, wherein text characters embedded in the image file are recognized;
means for converting the recognized text characters to corresponding Braille codes wherein the recognized text characters to corresponding Braille codes conversion step further includes means for converting Universal Character Set Transformation Format-8 (UTF-8) text to 8-Dot Unicode Braille language format, wherein the Universal Character Set Transformation Format-8 (UTF-8) text to 8-Dot Unicode Braille language format step further include means for using an open source Braille translator having a library that supports literary Braille, wherein the using an open source Braille translator step further include means for using open source Braille translator Liblouis, the Liblouis translator taking UNICODE or ASCII and mapping it with Braille so that each character has its own mapping so that errors are eliminated; and
a dynamic Braille tactile display device connected to a second set of the GPIO terminals, the dynamic Braille tactile display device dynamically tactilely displaying the corresponding Braille codes to the user.

20. The portable document format (PDF) file to Braille code conversion system according to claim 19, further comprising:
a battery management system monitoring voltage of a power source of the portable document format (PDF) file to Braille code conversion system; and
a booster circuit stepping up voltage for use by the microprocessor.
